(19) United States
(12) Patent Application Publication
(10) Pub. No.: US 2026/0212218 A1
(43) Pub. Date: Jul. 23, 2026

(54) METHOD FOR QUESTION ANSWERING OVER LIST DATA BASED ON A LARGE MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventor: Yiming FENG, Beijing (CN)

(73) Assignee: BEIJING BAIDU NETCOM SCIENCE TECHNOLOGY CO., LTD., Beijing (CN)

(21) Appl. No.: 19/569,922

(22) Filed: Mar. 17, 2026

(30) Foreign Application Priority Data
Mar. 19, 2025 (CN) 202510325399.9

(51) Int. Cl. G06N 5/022; G06F 16/2452

(52) U.S. Cl. CPC G06N 5/022; G06F 16/24522

(57) ABSTRACT

Provided is a method for question answering over list data based on a large model, an electronic device and a storage medium, relating to the field of data processing technology, and especially to the field of natural language processing. The method includes: obtaining a question text; processing a known data list based on the question text using a large model, to generate structured associated data; performing optimization processing on the structured associated data, to generate a knowledge base collection; inputting the question text and the knowledge base collection into the large model, to enable the large model to generate an answer corresponding to the question text. The technical solution can enhance the model's focus on data, significantly improve the accuracy and efficiency of question answering over lists.

### CROSS-REFERENCE TO RELATED APPLICATIONS

The present application claims priority to Chinese Patent Application No. CN202510325399.9, filed with the China National Intellectual Property Administration on Mar. 19, 2025, the disclosure of which is hereby incorporated herein by reference in its entirety.

### TECHNICAL FIELD

The present disclosure relates to the field of data processing technology, and especially to the field of natural language processing, which can be used in application scenarios such as list data parsing, intelligent question answering, and in particular to a method, apparatus for question answering over list data based on a large model, device and storage medium.

### BACKGROUND

In recent years, with the rapid development of large model technology, it has demonstrated strong capabilities and broad application prospects in natural language processing tasks. However, when facing the specific scenario of question answering over list data, the application of large models still faces many challenges.

### SUMMARY

The present disclosure provides a method, apparatus for question answering over list data based on a large model, device and storage medium.

In a first aspect, the present disclosure provides a method for question answering over list data based on a large model, including:
obtaining a question text;
processing a known data list based on the question text using a large model, to generate structured associated data;
performing optimization processing on the structured associated data, to generate a knowledge base collection;
inputting the question text and the knowledge base collection into the large model, to enable the large model to generate an answer corresponding to the question text.

In a second aspect, the present disclosure provides an apparatus for question answering over list data based on a large model, including:
a question obtaining module configured to obtain a question text;
a model processing module configured to process a known data list based on the question text using a large model, to generate structured associated data;
an optimization processing module configured to perform optimization processing on the structured associated data, to generate a knowledge base collection;
an answer generating module configured to input the question text and the knowledge base collection into the large model, to enable the large model to generate an answer corresponding to the question text.

In a third aspect, the present disclosure provides an electronic device, including:
at least one processor; and
a memory connected in communication with the at least one processor;
wherein the memory stores an instruction executable by the at least one processor, and the instruction, when executed by the at least one processor, enables the at least one processor to execute the method of any embodiment of the present disclosure.

In a fourth aspect, the present disclosure provides a non-transitory computer-readable storage medium storing a computer instruction thereon, and the computer instruction is used to cause a computer to execute the method of any embodiment of the present disclosure.

In a fifth aspect, the present disclosure provides a computer program product including a computer program, and the computer program, when executed by a processor, executes the method of any embodiment of the present disclosure.

By adopting the solution of the present disclosure, it can enhance the model's focus on data, significantly improve the accuracy and efficiency of question answering over lists.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are intended to provide a better understanding of the present solution and do not constitute a limitation on the present disclosure.

FIG. 1 is a schematic flow diagram of a method for question answering over list data based on a large model according to an embodiment of the present disclosure;

FIG. 2 is a schematic flow diagram of list compression processing according to an embodiment of the present disclosure;

FIG. 3 is a schematic structural diagram of an apparatus for question answering over list data based on a large model according to an embodiment of the present disclosure;

FIG. 4 is a schematic scenario diagram of a method for question answering over list data based on a large model according to an embodiment of the present disclosure; and

FIG. 5 is a structural diagram of an electronic device used to implement a method for question answering over list data based on a large model according to an embodiment of the present disclosure.

### DETAILED DESCRIPTION

Exemplary embodiments of the present disclosure will be described below in combination with the accompanying drawings, which includes various details of the embodiments of the present disclosure to facilitate understanding and should be considered merely illustrative. Accordingly, those of ordinary skill in the art should recognize that various changes and modifications can be made to the embodiments described herein without departing from the scope of the present disclosure. Similarly, for the sake of clarity and conciseness, descriptions of well-known functions and structures are omitted from the following description.

The term “and/or” herein is merely an association relationship describing associated objects, indicating that three relationships may exist. For example, “A and/or B” may represent three cases: A exists alone, both A and B exist, or B exists alone. The term “at least one” herein represents any one of multiple types or any combination of at least two of the multiple types. For example, “including at least one of A, B, or C” may represent including any one or more elements selected from a set consisting of A, B, and C. The terms “first” and “second” herein are used to refer to and distinguish between a plurality of similar technical terms, and do not mean limiting an order or limiting that there are only two. For example, a “first feature” and a “second feature” refer to two categories/two features, wherein the first feature may be one or more, and the second feature may also be one or more.

Furthermore, in order to better illustrate the present disclosure, numerous specific details are provided in the following detailed description. Those skilled in the art should understand that the present disclosure may be practiced without some of these specific details. In some instances, methods, means, elements, and circuits well-known to those skilled in the art have not been described in detail, so as to highlight the gist of the present disclosure.

Before introducing the technical solutions of the embodiments of the present disclosure, technical terms that may be used in the present disclosure are further described as follows:
list data: a data structure used to organize and store a plurality of data items, which can arrange data items in a certain order to form an iterable object, typically existing in the form of tables, arrays, or rows and columns. List data may contain multi-dimensional data, commonly found in spreadsheets (Excel), database records, and system-exported data files.

In related art, in a scenario of question answering over list data, the application of a large model still faces many challenges, including difficulties in question answering over large-scale list data, complex list structure, scattered information, confusion of information in adjacent rows, deviation in semantic understanding, and the like. Question answering over large-scale list data refers to the situation where when a length of input list data exceeds the limit of a predefined maximum context length (number of tokens) of the model, the system will automatically truncate the data content beyond the limit, resulting in the loss of key information, which seriously affects the accuracy and completeness of the generated answers by the model. The problems of complex list structure and scattered information refer to the fact that list data typically contains multiple rows and columns, with information scattered across different cells. This makes it difficult for a large model to accurately understand and correlate relevant information, thereby reducing the accuracy of question answering. The problem of confusion of information in adjacent rows refers to the potential similarity in semantics or structure between adjacent rows in a list, which can easily lead to confusion for a model and generate incorrect responses. The problem of deviation in semantic understanding refers to the fact that list data often contains a large number of professional terminology and abbreviations. A large model is prone to having deviation in semantic understanding, resulting in incorrect responses or irrelevant answers.

In order to at least partially solve one or more of the above-mentioned problems and other potential problems, the present disclosure proposes a method for question answering over list data based on a large model, which increases the model's focus on data, significantly improving the accuracy and efficiency of question answering over list data.

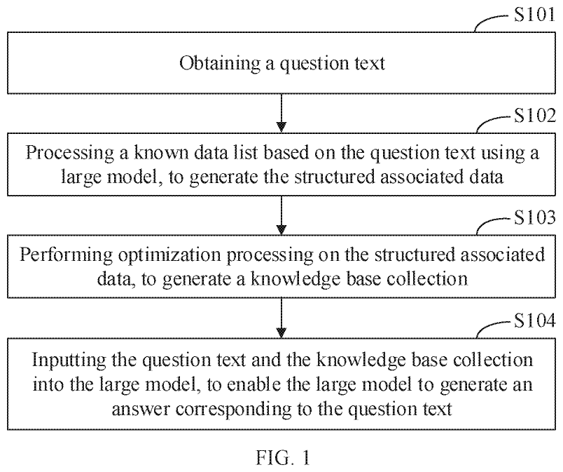

An embodiment of the present disclosure provides a method for question answering over list data based on a large model. FIG. 1 is a schematic flow diagram of a method for question answering over list data based on a large model according to an embodiment of the present disclosure, the method for question answering over list data based on a large model can be applied to an apparatus for question answering over list data based on a large model. The apparatus for question answering over list data based on a large model is located in an electronic device. The electronic device includes but is not limited to fixed devices and/or mobile devices. For example, fixed devices include but are not limited to servers, which can be cloud servers or regular servers. For example, mobile devices include but are not limited to list data parsing devices or intelligent question-answering devices, which can be mobile phones, tablet computers, or the like. In some possible implementations, the method for question answering over list data based on a large model can also be implemented by a processor invoking computer-readable instructions stored in a memory. As shown in FIG. 1, the method for question answering over list data based on a large model includes:
S101: obtaining a question text.
S102: processing a known data list based on the question text using a large model, to generate the structured associated data.
S103: performing optimization processing on the structured associated data, to generate a knowledge base collection.
S104: inputting the question text and the knowledge base collection into the large model, to enable the large model to generate an answer corresponding to the question text.

Here, the question text is a natural language query inputted by the user, intended to obtain information related to the content they are interested in from the list data. In an embodiment of the present disclosure, the question text usually contains specific query objectives, which may involve filtering conditions, data aggregation, or trend analysis.

In an embodiment of the present disclosure, a question entered by the user in the system interface can be treated as the question text, which is then parsed using Natural Language Processing (NLP) technology. Illustratively, the parsing process can include extracting a keyword, recognizing sentence intent, analyzing a question category, and the like.

Here, the known data list is the original data resource that already exists within the system and is associated with the user's query. In an embodiment of the present disclosure, the known data list can come from a database, a file, or an external acquisition system. Specifically, the known data list typically has diverse content, complex structure, and may contain redundant information or data that is difficult for the model to directly understand.

Here, the large model refers to a complex language model trained based on deep learning technology. In an embodiment of the present disclosure, the large model possesses powerful language comprehension and generation capabilities, enabling functions such as natural language question-answering and data reasoning. Specifically, the large model is capable of generating answers by comprehending a question text and content in a knowledge base.

In an embodiment of the present disclosure, a known data list and a question text can be inputted into the large model. After analyzing the requirements of the question text, the large model processes the data in the known data list, thereby generating structured data. Illustratively, the process of processing data in the known data list can include operations such as field extraction, relationship mapping, contextual association and the like.

Here, the knowledge base collection is a queryable content organization method generated based on structured associated data. In an embodiment of the present disclosure, the knowledge base collection can be characterized by regularity, optimization, and ease of retrieval, enabling the model to accurately answer a question. Specifically, the knowledge base collection can include background information, data summaries, statistical results related to the questions.

In an embodiment of the present disclosure, structured data can undergo further optimization processing. Optimized data is organized into a knowledge base collection, facilitating subsequent processing. Illustratively, the process of optimization processing can include removing redundant information, completing missing data, unifying data formats, calculating statistical results, and the like. The knowledge base can be stored in the form of graphs, tables, or key-value pairs.

In an embodiment of the present disclosure, the question text can be inputted together with the knowledge base collection into the large model, which performs reasoning and generates an answer based on the content of the knowledge base, and outputs the answers in natural language form by combining language generation technology.

The technical solution of the embodiments of the present disclosure can parse and process complex structured list data swiftly, filter out information pertinent to a question by means of the language comprehension capabilities of a large model, thus minimizing manual intervention. After the original list data undergoes structural processing and knowledge base construction, data can be systematically organized, facilitating subsequent querying and analysis, thereby maximizing the application value of the data. By integrating knowledge base optimization with the generation capabilities of the large model, it can accurately comprehend the intent of a user's question and generate a highly relevant answer, enhancing the professionalism and practicality of a question-answering system. Through automated data processing and question-answering generation, the system can reduce labor costs, deliver intelligent information services, and boost efficiency.

In some embodiments, the processing of the known data list based on the question text using the large model, to generate the structured associated data, includes: extracting a column definition from the known data list using the large model; extracting a column related to the question text from the known data list according to the question text and the column definition using the large model, to generate a first associated list; and extracting data of a relevant row from the first associated list according to the question text and the column definition using the large model, to generate the structured associated data.

Here, the column definition refers to the process and result of describing the content and attributes of each column in list data. In an embodiment of the present disclosure, the column definition can include information such as column name, data type, and semantic meaning, aiding the model in understanding the purpose and meaning of each column in the list. Specifically, by using the column definition, the large model can accurately determine which column is relevant to a question, thereby enhancing the accuracy of data extraction.

In an embodiment of the present disclosure, the structure of a known data list can be parsed by the large model, and the column definition can be identified and generated based on a header row or other metadata of the list. Illustratively, the meaning of a column name can be parsed first, and the data type of a column can be inferred simultaneously. Finally, the purpose of a column can be determined according to a contextual relationship and semantic information between columns, and a determination result can be used as the column definition.

Here, the first associated list is a sub-list composed of columns that are filtered from the original data list based on the question text and are relevant to the question. In an embodiment of the present disclosure, the first associated list includes only columns that are directly related to the intent of the question, while ignoring columns that are unrelated to the question.

In an embodiment of the present disclosure, a column directly related to the question intent can be filtered out by combining the question text with the column definition by a large model. For example, a keyword and core intent in the question text can be analyzed first, then the keyword in the question text is compared with information in the column definition to determine which column is relevant to the question, and the relevant column is finally extracted as the first association list for subsequent processing.

In an embodiment of the present disclosure, structured associated data can be generated by filtering and processing row data by the large model in combination of the question text and content from the first association list. Illustratively, a filtering condition in the question text can be analyzed first, followed by filtering out eligible row data using the information in the column definition. Finally, the filtered row data can be combined with the column to generate structured associated data. Specifically, the structured associated data is an optimized subset that facilitates subsequent question-answering tasks.

In this way, extracting a column definition can help the large model fully understand the meaning of a data column, avoid misjudgments caused by an ambiguous column name or complex semantics, and ensure the accuracy of data processing. By generating the first associated list, irrelevant columns in the original data list are filtered out, leaving only relevant columns, which reduces the burden on subsequent data processing and improves data processing efficiency. By dynamically selecting relevant columns and rows, it can adapt to different question scenarios, enhancing flexibility and generalization ability. By gradually extracting a column definition, a relevant column, and data of a relevant row, a hierarchical processing logic for a complex question is realized. The filtering process of columns and rows simplifies the original data into structured associated data related to a problem, significantly reducing the complexity of the data, thereby accelerating the reasoning process of large models.

In some embodiments, the processing of the known data list based on the question text using the large model, to generate the structured associated data, includes: determining a data type of a target column in the first associated list according to the column definition; determining a constraint for filtering data of a relevant row according to the data type; and extracting the data of the relevant row from the first associated list according to the constraint, to generate the structured associated data.

Here, a data type is a description of the category and format of data, used to define the properties and purpose of a column of data. In an embodiment of the present disclosure, the data type helps the model understand the meaning of each column of data and the types of operations that can be performed. Specifically, the definition of the data type determines how the column data is processed in subsequent operations.

Here, a target column is the one that requires the determination of its data type, and it is the specific column that needs to be processed or referenced in the association operation. Its data type can be directly obtained through the column definition. Preferably, the target column can be any column in the first associated list.

In an embodiment of the present disclosure, the column definition of the first associated list can be parsed and the data type of each column can be identified by the large model. Illustratively, the data type can be identified through a column name or an example value, or analyzed in conjunction with contextual semantics; the data types can include time, numerical values, text, and so on.

Here, a constraint is a rule extracted based on the question text and the column definition, and is used to filter out a row from the data that meets the requirements of the question. In an embodiment of the present disclosure, a constraint can be generated according to the data type and enable specifying a filtering rule.

In an embodiment of the present disclosure, a corresponding constraint can be generated based on a keyword and intent of the question text in combination with a data type of each column in the column definition. For example, for time-type data, time-related information can be extracted from the question text to generate a time range constraint; for numerical-type data, numerical constraint information can be extracted from the question text to generate a numerical range constraint; for text-type data, a keyword can be extracted from the question text as a matching condition.

In an embodiment of the present disclosure, the generated constraint can be applied to the first associated list using the large model to filter out row data that meets the constraint. For example, the data of a row in the first associated list can be traversed, and whether it meets the constraint can be determined row by row. Subsequently, data of all rows that meets the constraint can be extracted and organized into structured associated data.

By specifying the data type of a column, an appropriate processing method can be selected based on the type, significantly enhancing the precision of data operations and preventing data processing errors. Through a process of dynamically inferring a constraint based on the question text and the column definition, it can automatically adapt to different question requirements, reducing the need for a user to manually intervene with a complex filtering condition. By defining a column type and a filtering condition in advance, redundant processing of irrelevant data is avoided, data rows relevant to the question can be quickly filtered out, thus improving data extraction efficiency. By generating the structured associated data, it can ensure that data input to the large model is highly relevant, thereby enhancing the accuracy of question-answering generation and contextual relevance.

In some implementations, dynamic filtering of a list column can be performed based on a user's question first. By feeding the user question and all column definitions of the list into the large model, the large model can understand and select a column related to the question, achieving dynamic column compression of the list.

Furthermore, after filtering out a column of a certain attribution, the user question can be further analyzed using the large model and whether the question only involves some enumeration values can be determined, thereby irrelevant rows of data are filtered out and the row size of the list is compressed. This method is particularly suitable for low-dimensional columns, that is, columns with a small number of enumeration values, such as sales regions, product categories, and on-sale statuses.

Illustratively, taking “for sale status” as an example, suppose a list contains three statuses: “for sale”, “out of stock”, and “pre-sale”, and the user's question only focuses on “for sale” products. Through the analysis of the question using the large model, the user's demand range can be quickly identified, thereby filtering out data rows related to “out of stock” and “pre-sale”, significantly reducing the number of rows in the list. This not only reduces the input data volume of the model, but also improves the efficiency and accuracy of question answering.

In this way, through the aforementioned column compression and row compression, the system can quickly filter out irrelevant data rows and generate a highly compressed sub-list that is highly relevant to the question.

FIG. 2 is a schematic flow diagram of list compression processing. As shown in FIG. 2, the processing method can include:
S201: performing dynamic column filtering based on a user question. By feeding the user question and all column definitions of the list into the large model, the model is enabled to autonomously understand and select a column related to the question, achieving column selection for a dynamic list.
S202: based on a column filtering result of the large model, extracting a relevant column and removing an irrelevant column, thereby filtering out an irrelevant data column and compressing a column size of the list.
S203: after filtering out a column of a certain attribute, further analyzing the user question using the large model, determining whether the question only involves some enumeration values, and then selecting a row related to the question, achieving row selection for a dynamic list. Specifically, in order to reduce the capability requirements of the large model due to row compression, a prompt can be written separately for each attribute column that can use row compression, and called concurrently after column compression.
S204. based on the row selection result from the large model, extracting a relevant row and removing an irrelevant row, thereby filtering out an irrelevant data row and reducing a row size of the list.

It should be understood that the schematic diagram shown in FIG. 2 is merely exemplary and not restrictive, and it is scalable. Those skilled in the art can make various obvious changes and/or substitutions based on the example of FIG. 2, and the resulting technical solutions still fall within the disclosure scope of the embodiments of this disclosure.

In some embodiments, the processing of the known data list based on the question text using the large model, to generate the structured associated data, includes: extracting a question keyword and a query condition according to the question text using the large model; generating a structured query language based on the question keyword and the query condition using the large model; and extracting the structured associated data related to the question text from the known data list using the structured query language.

Here, a question keyword refers to a core word or phrase extracted from the question text, which can reflect the main intent of the question and the key points of data query. In the embodiment of the present disclosure, the question keyword can be used to help the model understand the user's question and determine the data range and calculation method that need to be processed.

Here, a query condition is a specific constraint or rule extracted from the question text for filtering data. In the embodiment of the present disclosure, the query condition can be generated based on the question keyword and contextual semantics, explicitly indicating the logic of data extraction.

In an embodiment of the present disclosure, an inputted question in natural language can first be subjected to word segmentation, semantic analysis, and structural parsing using the large model to extract a core keyword. For example, the processing capabilities of the large model on natural language can be utilized to identify important nouns, verbs, or adjectives in the question, determine the relative importance of the keyword based on contextual semantics and subsequently select vocabulary with higher relative importance as a core keyword. Afterwards, a query condition of the question is analyzed by combining the keyword and contextual semantics using the large model. For example, for questions related to the time dimension, a time point or time range involved in the question can be identified; for questions related to the data dimension, an aggregation or presentation method required in the question can be identified; for questions related to the field dimension, a required data column or indicator can be identified.

Here, Structured Query Language (SQL) is a programming language used for managing and extracting data, applicable to structured data such as databases or data tables. In the embodiment of the present disclosure, Structured Query Language refers to an SQL statement generated from a question keyword and a query condition, used to extract structured data related to the question from a known data list. It can extract target data through filtering conditions, field selection, and calculation logic.

In an embodiment of the present disclosure, an SQL statement or an equivalent structured query language is automatically generated based on the extracted keyword and query condition using the large model. Illustratively, the syntax rules of SQL are matched based on the extracted keyword and query condition using the large model, subsequently the information in the query condition is mapped to the fields of a known data list, and finally the mapped fields, conditions, and logic are organized into a complete SQL statement.

In an embodiment of the present disclosure, a generated SQL statement or structured query language is executed to extract the structured associated data that meets the query condition from the original data list. Illustratively, the SQL statement is sent to the known data list through an interface or query tools such as SQL query engine, data analysis platform, and then the SQL statement is executed to obtain result data from the known data list that meets the condition. This result data is treated as structured associated data.

In this way, by extracting a core keyword and query condition from natural language by the large model and automatically generating a structured query language, the technical requirements for a user are significantly reduced, enabling a non-technical user to query complex data through natural language. Through the dynamic generation of a question keyword and query condition, it can ensure that the generated query statement highly aligns with the user's actual question, thereby improving the accuracy of data filtering. With the automatically generated query language, it can quickly locate data related to the question without manual filtering, optimizing the efficiency of data acquisition, especially when dealing with large-scale data, the effect is even more significant.

In some implementations, if an attribute column of a list have characteristics of being enumerable and having a limited number of values, and the semantic independence between columns is strong, a technical solution of the Natural Language to SQL (n2sql) technology based on a large model can be adopted for list compression. This solution can effectively reduce the complexity of data storage and processing, while maintaining data integrity and queryability. In the final answering stage, the generated SQL statement and its execution result need to be inputted into the large model together, and the large model will further analyze and interpret the results to generate the final answer that meets the user's needs.

Thus, n2sql technology excels in list compression, significantly enhancing data storage and query efficiency.

In some embodiments, the performing of the optimization processing on the structured associated data, to generate the knowledge base collection includes: extracting header information according to the structured associated data; the header information including a column name and its corresponding data type; generating a knowledge list according to the structured associated data and the header information; the knowledge list including a structured data entry corresponding to the header information; performing row order adjustment and structural optimization on the knowledge list, to generate the knowledge base collection.

Here, the header information refers to a column name and its corresponding data type in a structured data table, which describes the structure of the data table. In an embodiment of the present disclosure, header information includes a column name, that is, the name of each column, used to describe the content or attribute of the data in that column. Furthermore, header information also includes its corresponding data type, that is, the data type of each column, which can include time, numerical values, text, and the like.

In an embodiment of the present disclosure, a column name of the table can be extracted first from the structured associated data. Subsequently, the data in each column is analyzed to determine its data type. Finally, the column name and its corresponding data type are integrated, generating the header information. Specifically, the header information can specify the purpose and characteristics of each column of data in the table, facilitating subsequent processing and optimization operations.

Here, a knowledge list is a set of structured data entries extracted from the structured associated data and organized according to the header information. In an embodiment of the present disclosure, each knowledge list is a row of data in the table, containing a field value corresponding to the column name in the header; the knowledge list can be organized according to the structure of the header information, representing a collection of structured data entries.

In an embodiment of the present disclosure, a column name in the header information can be used as a field name to extract each row of data entries from the structured associated data, which are organized into a set of structured key-value pairs, and each data entry is organized according to an order of the header column name and data type, thereby generating a knowledge list.

Here, a knowledge base collection is a content set generated through row order adjustment and structural optimization based on the knowledge list, which features higher organization and usability, facilitating retrieval and analysis. In an embodiment of the present disclosure, the knowledge base collection includes optimized data, with data formats and organization methods are adjusted to accommodate more efficient query and reasoning requirements. Specifically, the knowledge base collection can be stored in the form of a database, table file, key-value pair structure, or knowledge graph, suitable for more complex knowledge management and question-answering scenarios.

In an embodiment of the present disclosure, the order of data entries in the knowledge list can be rearranged according to requirements. For example, the entries can be sorted by a certain column value while being classified by the priority of a specific field. Specifically, an abnormal data entry that does not meet the condition can be excluded during the rearrangement process. Subsequently, the storage structure of the data can be optimized to make it more efficient. For instance, the knowledge list can be converted into a database table or a knowledge graph to adapt to specific storage and retrieval requirements. Specifically, redundant information can be deduplicated or compressed, and indexes, association relationships, or supplementary attributes can be added to data entries.

In this way, by extracting and normalizing the header information, the consistency and clarity of the data structure are ensured, laying the foundation for subsequent optimization and retrieval. By generating a knowledge list, key data entries can be organized and irrelevant information can be eliminated, reducing search and matching time in a large amount of data. By sorting and optimizing the data entries in the knowledge base collection, questions can be answered, reasoning can be supported, or reports can be generated more efficiently.

In some embodiments, the generating of the knowledge list according to the structured associated data and the header information includes: generating a markup language list using the associated data and the header information; wherein the markup language list contains at least two header information items and their corresponding data entries; and treating the markup language list as the knowledge list.

Here, Markdown is a lightweight markup language used for formatting and structuring text through simple symbols and syntax. In an embodiment of the present disclosure, a Markdown list refers to structured data represented using Markdown syntax, which can easily present the header information and corresponding data entries, facilitating reading and organization.

In an embodiment of the present disclosure, data entries can be first extracted from the structured associated data, where each entry contains a data record of each row in the structured associated data. Subsequently, a column name and its corresponding field definition can be obtained from the header information. Finally, the header information and data entries can be combined and organized into a Markdown list according to the Markdown syntax format.

In an embodiment of the present disclosure, the generated Markdown list can be directly used as the representation of the knowledge list. Specifically, the knowledge list can be in the format of a table or a structured bullet list, and the specific format can be determined according to the actual application scenarios.

By using Markdown to present structured data in table or list format, data entries become more intuitive and easier to understand. By directly converting data into a knowledge list in Markdown format, the complexity of format conversion is reduced, while the flexibility and adaptability of the data is enhanced.

In some implementations, when handling list data with a large number of rows, the large model may forget the header information corresponding to a certain column due to context limitations, resulting in the loss of key information. To avoid this issue, when organizing list data, the memory and comprehension abilities of the model can be enhanced by repeatedly emphasizing the header information. For example, the list data can be organized in Markdown format, with header information repetitively inserted between rows, to ensure that the model can accurately identify the meaning of each column.

In this way, the problem of the large model forgetting the header information when processing list data with a large number of rows can be effectively avoided. This enhances the model's understanding of the list structure, ensuring that key information is retained in long text contexts, thereby improving the accuracy and reliability of data processing.

In some embodiments, the generating of the knowledge list according to the structured associated data and the header information includes: concatenating data of a target row in the structured associated data with the header information, generating a knowledge sentence; traversing data of all the target rows in the structured associated data, generating a list of knowledge sentences; and treating the list of knowledge sentences as the knowledge list.

Here, the target row refers to a specific row to be processed in the structured data, which can be any row or a row filtered as needed. By concatenating the data of the target row with the header, a knowledge sentence that meets business requirements can be automatically generated. Preferably, the target row can be any row in the structured associated data.

Here, a knowledge sentence is a natural language description generated by concatenating certain row of data from structured associated data with the header information, used to express specific information of that row of data. In the embodiment of the present disclosure, a knowledge sentence is a method of converting data into human-readable semantic expressions, generated by associating data values with their corresponding header information.

In an embodiment of the present disclosure, each row of data in the structured associated data can be traversed, and the column names and their corresponding field values in the header information can be extracted and concatenated one by one into a natural language description. Specifically, a template for natural language description can be customized according to the needs of the field. For example, a row of data could be “2023-01-01, Product A, 5000”, and the knowledge sentence generated by concatenating the data with the header information could be “On Jan. 1, 2023, the product name is ‘Product A’, and the sales amount is 5000.”

Here, the knowledge sentence list is a sequence set of natural language descriptions generated by concatenating each row of structured data with the header information. In an embodiment of the present disclosure, the knowledge sentence list can represent the row of data in structured data in the form of a natural language sentence, thereby forming a list.

In an embodiment of the present disclosure, a knowledge sentence corresponding to each row of structured associated data can be generated sequentially, and all generated knowledge sentences can be stored as a list of knowledge sentences.

In an embodiment of the present disclosure, the generated knowledge sentence list can be directly used as a representation of the knowledge list. Specifically, the knowledge list stores the semantic description of each row of data in natural language, facilitating subsequent knowledge base construction and question-answering tasks.

In this way, by transforming raw structured data into a knowledge sentence expressed in natural language, it facilitates quick comprehension of data content, especially catering to the communication needs of a non-technical user or in business scenarios. Since a knowledge sentence is a knowledge representation in natural language form, it can be directly applied to a question-answering system, serving as part of the answers provided to a user, thereby enhancing overall operational efficiency. By constructing a knowledge base using knowledge sentences in natural language form, it can be directly utilized to build a text-based knowledge base without additional structured processing steps, reducing the cost of knowledge base construction and maintenance.

In some implementations, for a general semantic large model, a list can be constructed by concatenating the header information and a corresponding value into a complete sentence. This approach effectively prevents the model from omitting key information when processing list data, while enhancing data readability and semantic comprehension capabilities.

In this way, the problem of the large model forgetting the header information when processing list data with a large number of rows can be effectively avoided. This enhances the model's understanding of the list structure, ensuring that the key information is retained in long text contexts, thereby improving the accuracy and reliability of data processing.

In some embodiments, the performing of the row order adjustment and structural optimization on the knowledge list, to generate the knowledge base collection, includes: traversing data of each target row in the knowledge list and arranging the target rows with a same column value in a centralized manner; splitting the knowledge list according to the target row based on a preset identifier in the known data list, to generate multiple sub-datasets; and performing structural optimization on the sub-datasets, to generate the knowledge base collection.

Here, a target row can be any row in the knowledge list or a filtered row as needed. Preferably, the target row can be any row in the knowledge list.

Here, a sub-dataset is a small dataset obtained by being split from a knowledge list according to a certain rule, with each sub-dataset containing a portion of the row data from the knowledge list. In an embodiment of the present disclosure, the sub-dataset can be regarded as a data set separated from a larger knowledge list.

In an embodiment of the present disclosure, each knowledge statement in the knowledge list can be traversed, and the knowledge list can be grouped according to a certain column value, with rows having a same column value being grouped together. Illustratively, the column name “product name” can be used as a grouping condition, meaning rows where the product name is “Product A” can be grouped together, rows where the product name is “Product B” can be grouped together, and so on.

Here, a preset identifier serves as a basis or rule for classifying or splitting data in the knowledge list. In an embodiment of the present disclosure, the preset identifier can be a certain field or specific tag value in structured data, through which data can be grouped and classified into different sub-datasets.

In an embodiment of the present disclosure, an identifier (such as * or a serial number) can be prepended to a complete sentence in each row to explicitly indicate that each row of the large model is an independent entity, thus avoiding contextual interference. Furthermore, an identifier can be used as a splitting criterion to divide each row of the knowledge list into a sub-dataset. Similarly, a value of a certain column or a specific condition can also be used as an identifier, so that for each row of data in the knowledge list, the sub-dataset to which it belongs can be determined based on the identifier.

In an embodiment of the present disclosure, further processing or adjustment can be performed on the sub-dataset to make it more efficient and suitable for storage and retrieval. Illustratively, the processing or adjustment process can include removing redundant information, transforming the sub-dataset into a more advanced hierarchical structure, format conversion, and/or index construction.

By splitting the knowledge list into multiple sub-datasets based on the column value or the identifier, data can be better organized and managed, resulting in a clearer structure that facilitates subsequent queries, analysis, and retrieval. Optimizing these sub-datasets can significantly enhance storage efficiency, reduce redundancy, and improve data retrieval efficiency. Additionally, the splitting and optimization of sub-datasets can accommodate the continuously expanding data scale and support data reuse at the same time.

In some implementations, due to the high information density of list data, the large model is prone to confusion when processing adjacent rows. Therefore, it can first sort the list data by a value of each column, arranging rows with the same column value together as much as possible. Subsequently, after sorting, if there are still variations between different column values, which may lead to confusion among adjacent rows, a serial number character (such as * or a serial number) can be added before the complete sentence of each row to explicitly indicate that each row is an independent entity, thus avoiding contextual interference.

In this way, the distinction between adjacent lines can be achieved, effectively solving the problem of semantic confusion between adjacent lines.

In some embodiments, the inputting of the question text and the knowledge base collection into the large model, to generate the answer corresponding to the question text using the large model, includes: extracting inherent knowledge from the knowledge base collection, where the inherent knowledge includes structured data related to the question text; generating a prompt instruction according to the inherent knowledge, the prompt instruction being used to guide the large model to generate an answer related to the question text; inputting the knowledge base collection, the prompt instruction, and the question text into the large model, to obtain an answer corresponding to the question text generated by the large model through reasoning.

Here, inherent knowledge refers to structured data extracted from a knowledge base collection and is relevant to the question text. The data originates directly from the knowledge base and serves as a partial answer to the question text or provides key information that supports the answer. In an embodiment of the present disclosure, inherent knowledge is content that is explicitly present in the knowledge base, and is the data associated with the question that can be retrieved from the knowledge base through operations such as matching and retrieval. Specifically, inherent knowledge can provide accurate and targeted contextual or background information for the model to generate answers, reducing ambiguity or uncertainty when the model generates answers.

In an embodiment of the present disclosure, a keyword or a specific field of the question text is first analyzed to determine core information of the question. Then, a relevant data record is matched from the knowledge base collection using the keyword or field from the parsing result. Finally, the retrieved data record can be used as inherent knowledge. Similarly, attributes such as column definition and data structure can also be embedded as inherent knowledge into the setting of a system role of the large model, which can significantly enhance the model's memory capacity and contextual understanding ability.

Here, the prompt instruction is a designed input text used to guide the large model to generate an answer related to the question text. In an embodiment of the present disclosure, the prompt instruction combines the question text with the extracted inherent knowledge and expresses it in natural language or in a way that the model can understand, providing a clear task instruction.

In an embodiment of the present disclosure, inherent knowledge can be organized in natural language form and concatenated with the question text. Specifically, the structure and language style of the prompt can be dynamically adjusted according to the requirements of the large model, ensuring that the model can accurately understand the task.

In an embodiment of the present disclosure, the generated prompt instruction is used as a main input, and is inputted into the large model together in combination with the knowledge base collection and the question text. Furthermore, the large model can parse the prompt, understand the content of the question and the inherent knowledge, and then use the inherent knowledge to perform reasoning, combining the question text to generate an answer.

In this way, by extracting the inherent knowledge from the knowledge base and inputting into the large model, the foundation for answer generation becomes more explicit, reducing errors that may occur when the model relies on memory to generate answers. By specifying the question task through a prompt, the large model is guided to focus on the question itself, effectively reducing ambiguity or irrelevant information when generating answers. The reasoning scope of the model can be limited by the inherent knowledge and the prompt word, reducing unnecessary generation calculations, and thus improving reasoning efficiency.

In some implementations, as question answering over a list falls within the scope of knowledge base question answering, list data can serve as inherent background knowledge for this conversation. Typically, the large model supports the setting of a system role in a single question-answering session. The system role can be responsible for guiding, controlling, and organizing conversation flow, ensuring that the context, tasks, and goals of the conversation are executed correctly. Therefore, embedding an attribute list as inherent knowledge into the setting of the system role can significantly enhance the model's memory and contextual understanding capabilities, thereby optimizing the question-answering effect.

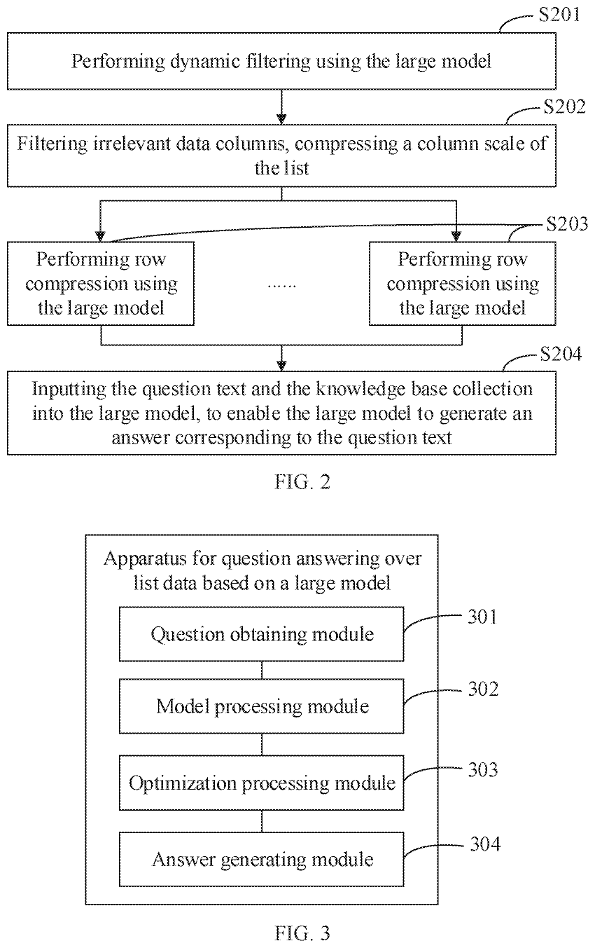

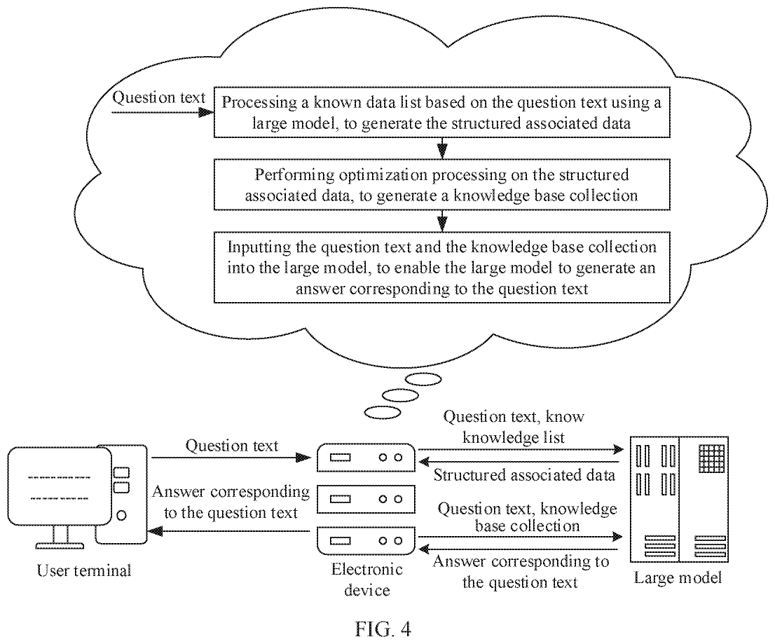

An embodiment of the present disclosure provides an apparatus for question answering over list data based on a large model. As shown in FIG. 3, the apparatus can include: a question obtaining module 301 configured to obtain a question text; a model processing module 302 configured to process a known data list based on the question text using the large model, to generate structured associated data; an optimization processing module 303 configured to perform optimization processing on the structured associated data, to generate a knowledge base collection; an answer generating module 304 configured to input the question text and the knowledge base collection into the large model, to enable the large model to generate an answer corresponding to the question text.

In some embodiments, the model processing module 302 includes: a definition extracting sub-module configured to extract a column definition from the known data list using the large model; a first associating sub-module configured to extract a column related to the question text from the known data list according to the question text and the column definition using the large model, to generate a first associated list; and a data associating sub-module configured to extract data of a relevant row from the first associated list according to the question text and the column definition using the large model, to generate the structured associated data.

In some embodiments, the data associating sub-module is configured to determine a data type of a target column in the first associated list according to the column definition; determine a constraint for filtering data of the relevant row based on the data type; and extract the data of the relevant row from the first associated list according to the constraint, to generate the structured associated data.

In some embodiments, the model processing module 302 includes: a question extracting sub-module configured to extract a question keyword and a query condition according to the question text using the large model; a query generating sub-module configured to generate a structured query language based on the question keyword and the query condition using the large model; and a data extracting sub-module configured to extract the structured associated data related to the question text from the known data list using the structured query language.

In some embodiments, the optimization processing module 303 includes: a header extracting sub-module configured to extract header information according to the structured associated data, the header information including a column name and its corresponding data type; a knowledge list sub-module configured to generate a knowledge list according to the structured associated data and the header information; the knowledge list including a structured data entry corresponding to the header information; a knowledge collecting sub-module configured to perform row order adjustment and structural optimization on the knowledge list, to generate the knowledge base collection.

In some embodiments, the knowledge list sub-module is configured to generate a markup language list using the associated data and the header information; wherein the markup language list contains at least two header information items and their corresponding data entries; and treat the markup language list as the knowledge list.

In some embodiments, the knowledge list sub-module is configured to concatenate data of a target row in the structured associated data with the header information, generating a knowledge sentence; traverse data of all the target rows in the structured associated data, generating a list of knowledge sentences; and treat the list of knowledge sentences as the knowledge list.

In some embodiments, the knowledge collecting sub-module is configured to traverse data of a target row in the knowledge list and arrange the target rows with a same column value in a centralized manner; split the knowledge list according to the target row based on a preset identifier in the known data list, to generate multiple sub-datasets; and perform structural optimization on the sub-datasets, to generate the knowledge base collection.

In some embodiments, the answer generating module 304 includes: a knowledge extracting sub-module configured to extract inherent knowledge from the knowledge base collection, where the inherent knowledge includes structured data related to the question text; an instruction generating sub-module configured to generate a prompt instruction according to the inherent knowledge, the prompt instruction being used to guide the large model to generate an answer related to the question text; a model reasoning sub-module configured to input the knowledge base collection, the prompt instruction, and the question text into the large model, to obtain an answer corresponding to the question text generated by the large model through reasoning.

For descriptions of specific functions and examples of the various modules and sub-modules of the apparatus in the embodiments of the present disclosure, reference may be made to the relevant descriptions of corresponding steps in the above-mentioned method embodiments, and details are not repeatedly described herein.

The apparatus for question answering over list data based on a large model in the embodiments of the present disclosure can parse swiftly and process complex structured list data, filter out information pertinent to a question by means of the language comprehension capabilities of the large model, thus minimizing manual intervention. After the original list data undergoes structural processing and knowledge base construction, data can be systematically organized, facilitating subsequent querying and analysis, thereby maximizing the application value of the data. By integrating knowledge base optimization with the generation capabilities of the large model, it becomes possible to accurately comprehend the intent of a user's question and generate highly relevant answers, enhancing the professionalism and practicality of a question-answering system. Through automated data processing and question-answering generation, the system can reduce labor costs, deliver intelligent information services, and boost efficiency.

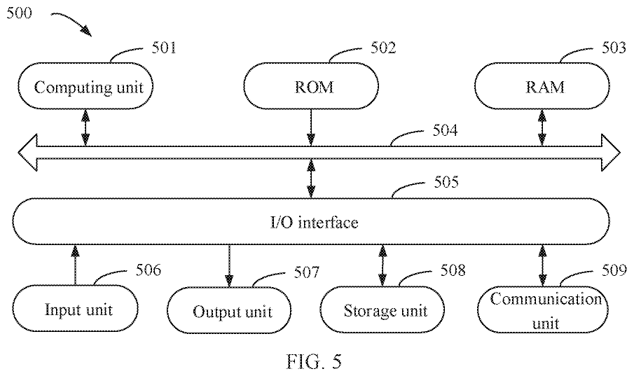

An embodiment of the present disclosure provides a schematic scenario diagram of the method for question answering over list data based on a large model, as shown in FIG. 4.

As mentioned earlier, the method for question answering over list data based on a large model provided in the embodiments of the present disclosure is applied to an electronic device. The electronic device is intended to represent various forms of digital computers, such as laptops, desktop computers, workstations, personal digital assistants, servers, blade servers, mainframe computers, and other suitable computers.

Specifically, the electronic device can perform the following operations: obtaining a question text; processing a known data list based on the question text using a large model, to generate structured associated data; performing optimization processing on the structured associated data, to generate a knowledge base collection; inputting the question text and the knowledge base collection into the large model, to enable the large model to generate an answer corresponding to the question text

It should be understood that the scenario diagram shown in FIG. 4 is merely illustrative and not restrictive. Those skilled in the art may make various obvious variations and/or substitutions based on the example of FIG. 4, and the resulting technical solutions still fall within the disclosure scope of the embodiments disclosed herein.

In the disclosed technical solution, the obtaining, storage, and application of user personal information involved are all in compliance with relevant laws and regulations, and do not violate public order and good customs.

According to an embodiment disclosed herein, the present disclosure further provides an electronic device, a readable storage medium, and a computer program product.

FIG. 5 is a structural block diagram of an electronic device 500 that can implement the embodiments of the present disclosure. Electronic devices are intended to represent various forms of digital computers, such as laptop computers, desktop computers, workstations, personal digital assistants, servers, blade servers, mainframes, and other suitable computers. Electronic devices may also represent various forms of mobile apparatuses, such as personal digital assistants, cellular telephones, smartphones, wearable devices, and other similar computing apparatuses. The components, their connections and relationships, and their functions illustrated herein are provided merely as examples, and are not intended to limit the implementation of the disclosure described and/or claimed herein.

As shown in FIG. 5, the device 500 includes a computing unit 501, which may perform various appropriate actions and processes according to a computer program stored in a Read-Only Memory (ROM) 502 or a computer program loaded from a storage unit 508 into a Random Access Memory (RAM) 503. In the RAM 503, various programs and data required for the operation of the device 500 may also be stored. The computing unit 501, the ROM 502, and the RAM 503 are connected to each other through a bus 504. An Input/Output (I/O) interface 505 is also connected to the bus 504.

A plurality of components in the device 500 are connected to the I/O interface 505, including: an input unit 506, such as a keyboard, a mouse, or the like; an output unit 507, such as various types of displays, speakers, or the like; a storage unit 508, such as a magnetic disk, an optical disk, or the like; and a communication unit 509, such as a network card, a modem, a wireless communication transceiver, or the like. The communication unit 509 allows the device 500 to exchange information/data with other devices through a computer network such as the Internet and/or various telecommunication networks.

The computing unit 501 may be various general-purpose and/or special-purpose processing components having processing and computing capabilities. Some examples of the computing unit 501 include, but are not limited to, a Central Processing Unit (CPU), a Graphics Processing Unit (GPU), various special-purpose Artificial Intelligence (AI) computing chips, various computing units running machine learning model algorithms, a Digital Signal Processor (DSP), and any appropriate processors, controllers, microcontrollers, or the like. The computing unit 501 performs the various methods and processes described above, such as the method for question answering over list data based on a large model. For example, in some embodiments, the method for question answering over list data based on a large model may be implemented as a computer software program tangibly contained in a machine-readable medium, such as the storage unit 508. In some embodiments, part or all of the computer program may be loaded and/or installed onto the device 500 via the ROM 502 and/or the communication unit 509. When the computer program is loaded into the RAM 503 and executed by the computing unit 501, one or more steps of the method for question answering over list data based on a large model described above may be performed. Alternatively, in other embodiments, the computing unit 501 may be configured to perform the method for question answering over list data based on a large model in any other appropriate manner (e.g., by means of firmware).

Various implementations of the systems and technologies described hereinabove may be implemented in digital electronic circuitry, integrated circuit systems, Field Programmable Gate Arrays (FPGAs), Application Specific Integrated Circuits (ASICs), Application-Specific Standard Products (ASSPs), System-on-Chip (SOC) systems, Complex Programmable Logic Devices (CPLDs), computer hardware, firmware, software, and/or combinations thereof. These various implementations may include: being implemented in one or more computer programs that are executable and/or interpretable on a programmable system including at least one programmable processor, which may be a special-purpose or general-purpose programmable processor, and which may receive data and instructions from a storage system, at least one input apparatus, and at least one output apparatus, and transmit data and instructions to the storage system, the at least one input apparatus, and the at least one output apparatus.

Program code for implementing the method of the present disclosure may be written in any combination of one or more programming languages. Such program code may be provided to a processor or controller of a general-purpose computer, a special-purpose computer, or other programmable data processing apparatuses, such that the program code, when executed by the processor or controller, causes the functions/operations specified in the flowcharts and/or block diagrams to be implemented. The program code may be executed entirely on a machine, partly on a machine, as a stand-alone software package partly on a machine and partly on a remote machine, or entirely on a remote machine or server.

In the context of the present disclosure, a machine-readable medium may be a tangible medium that may contain or store a program for use by an instruction execution system, apparatus, or device, or the combination thereof. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium would include an electrical connection based on one or more wires, a portable computer diskette, a hard disk, a Random Access Memory (RAM), a Read-Only Memory (ROM), an Erasable Programmable Read-Only Memory (EPROM), a flash memory, an optical fiber, a portable Compact Disk Read-Only Memory (CD-ROM), an optical storage device, a magnetic storage device, or any suitable combination thereof.

To provide interaction with a user, the systems and technologies described herein may be implemented on a computer having: a display apparatus for displaying information to the user (e.g., a Cathode Ray Tube (CRT) or a Liquid Crystal Display (LCD) monitor); and a keyboard and a pointing apparatus (e.g., a mouse or a trackball) through which the user may provide input to the computer. Other kinds of apparatuses may also be used to provide interaction with a user; for example, feedback provided to the user may be any form of sensory feedback (e.g., visual feedback, auditory feedback, or tactile feedback); and input from the user may be received in any form (including acoustic input, voice input, or tactile input).

The systems and technologies described herein may be implemented in a computing system that includes a back-end component (e.g., as a data server), or a computing system that includes a middleware component (e.g., an application server), or a computing system that includes a front-end component (e.g., a user computer having a graphical user interface or a web browser through which a user may interact with an implementation of the systems and technologies described herein), or a computing system that includes any combination of such back-end, middleware, or front-end components. The components of the system may be interconnected through any form or medium of digital data communication (e.g., a communication network). Examples of communication networks include a Local Area Network (LAN), a Wide Area Network (WAN), and the Internet.

A computing system may include a client and a server. The client and the server are generally remote from each other and typically interact through a communication network. The relationship between the client and the server is generated by computer programs running on respective computers and having a client-server relationship with each other. The server may be a cloud server, a server of a distributed system, or a server combined with blockchain.

It should be understood that the various forms of processes shown above may be used to reorder, add, or delete steps. For example, the steps described in the present disclosure may be performed in parallel, sequentially, or in a different order, as long as the desired results of the technical solutions disclosed in the present disclosure can be achieved, which is not limited herein.

The specific implementations described above do not constitute a limitation on the protection scope of the present disclosure. Those skilled in the art should understand that various modifications, combinations, sub-combinations, and substitutions may be made according to design requirements and other factors. Any modifications, equivalent substitutions, and improvements made within the principles of the present disclosure shall be included within the protection scope of the present disclosure.

What is claimed is:

1. A method for question answering over list data based on a large model, comprising:
obtaining a question text;
processing a known data list based on the question text using a large model, to generate structured associated data;
performing optimization processing on the structured associated data, to generate a knowledge base collection; and
inputting the question text and the knowledge base collection into the large model, to enable the large model to generate an answer corresponding to the question text.

2. The method of claim 1, wherein the processing of the known data list based on the question text using the large model, to generate the structured associated data, comprises:
extracting a column definition from the known data list using the large model;
extracting a column related to the question text from the known data list according to the question text and the column definition using the large model, to generate a first associated list; and
extracting data of a relevant row from the first associated list according to the question text and the column definition using the large model, to generate the structured associated data.

3. The method of claim 2, wherein the extracting of the data of the relevant row from the first associated list according to the question text and the column definition using the large model, to generate the structured associated data, comprises:
determining a data type of a target column in the first associated list according to the column definition;
determining a constraint for filtering data of a relevant row according to the data type; and
extracting the data of the relevant row from the first associated list according to the constraint, to generate the structured associated data.

4. The method of claim 1, wherein the processing of the known data list based on the question text using the large model, to generate the structured associated data, comprises:
extracting a question keyword and a query condition according to the question text using the large model;
generating a structured query language based on the question keyword and the query condition using the large model; and
extracting the structured associated data related to the question text from the known data list using the structured query language.

5. The method of claim 1, wherein the performing of the optimization processing on the structured associated data, to generate the knowledge base collection, comprising:
extracting header information according to the structured associated data, the header information including a column name and its corresponding data type;
generating a knowledge list according to the structured associated data and the header information, the knowledge list including a structured data entry corresponding to the header information; and
performing row order adjustment and structural optimization on the knowledge list, to generate the knowledge base collection.

6. The method of claim 5, wherein the generating of the knowledge list according to the structured associated data and the header information, comprises:
generating a markup language list using the associated data and the header information;
wherein the markup language list contains at least two header information items and their corresponding data entries; and
treating the markup language list as the knowledge list.

7. The method of claim 5, wherein the generating of the knowledge list according to the structured associated data and the header information, comprises:
concatenating data of a target row in the structured associated data with the header information, generating a knowledge sentence;
traversing data of all the target rows in the structured associated data, generating a list of knowledge sentences; and
treating the list of knowledge sentences as the knowledge list.

8. The method of claim 5, wherein the performing of the row order adjustment and structural optimization on the knowledge list, to generate the knowledge base collection, comprises:
traversing data of a target row in the knowledge list and arranging the target rows with a same column value in a centralized manner;
splitting the knowledge list according to the target row based on a preset identifier in the known data list, to generate multiple sub-datasets; and
performing structural optimization on the sub-datasets, to generate the knowledge base collection.

9. The method of claim 1, wherein the inputting of the question text and the knowledge base collection into the large model, to enable the large model to generate the answer corresponding to the question text, comprises:
extracting inherent knowledge from the knowledge base collection, the inherent knowledge including structured data related to the question text;
generating a prompt instruction according to the inherent knowledge, the prompt instruction being used to guide the large model to generate an answer related to the question text; and
inputting the knowledge base collection, the prompt instruction, and the question text into the large model, to obtain an answer corresponding to the question text generated by the large model through reasoning.

10. An electronic device, comprising:
at least one processor; and
a memory connected in communication with the at least one processor;
wherein the memory stores an instruction executable by the at least one processor, and the instruction, when executed by the at least one processor, enables the at least one processor to execute:
obtaining a question text;
processing a known data list based on the question text using a large model, to generate structured associated data;
performing optimization processing on the structured associated data, to generate a knowledge base collection; and
inputting the question text and the knowledge base collection into the large model, to enable the large model to generate an answer corresponding to the question text.

11. The electronic device of claim 10, wherein the instruction, when executed by the at least one processor, enables the at least one processor to execute the processing of the known data list based on the question text using the large model, to generate the structured associated data, by:
extracting a column definition from the known data list using the large model;
extracting a column related to the question text from the known data list according to the question text and the column definition using the large model, to generate a first associated list; and
extracting data of a relevant row from the first associated list according to the question text and the column definition using the large model, to generate the structured associated data.

12. The electronic device of claim 11, wherein the instruction, when executed by the at least one processor, enables the at least one processor to execute the extracting of the data of the relevant row from the first associated list according to the question text and the column definition using the large model, to generate the structured associated data, by:
determining a data type of a target column in the first associated list according to the column definition;
determining a constraint for filtering data of a relevant row according to the data type; and
extracting the data of the relevant row from the first associated list according to the constraint, to generate the structured associated data.

13. The electronic device of claim 10, wherein the instruction, when executed by the at least one processor, enables the at least one processor to execute the processing of the known data list based on the question text using the large model, to generate the structured associated data, by:
extracting a question keyword and a query condition according to the question text using the large model;
generating a structured query language based on the question keyword and the query condition using the large model; and
extracting the structured associated data related to the question text from the known data list using the structured query language.

14. The electronic device of claim 10, wherein the instruction, when executed by the at least one processor, enables the at least one processor to execute the performing of the optimization processing on the structured associated data, to generate the knowledge base collection, by:
extracting header information according to the structured associated data, the header information including a column name and its corresponding data type;
generating a knowledge list according to the structured associated data and the header information, the knowledge list including a structured data entry corresponding to the header information; and
performing row order adjustment and structural optimization on the knowledge list, to generate the knowledge base collection.

15. The electronic device of claim 14, wherein the instruction, when executed by the at least one processor, enables the at least one processor to execute the generating of the knowledge list according to the structured associated data and the header information, by:
generating a markup language list using the associated data and the header information;
wherein the markup language list contains at least two header information items and their corresponding data entries; and
treating the markup language list as the knowledge list.

16. A non-transitory computer-readable storage medium storing a computer instruction thereon, wherein the computer instruction is used to cause a computer to execute:
obtaining a question text;
processing a known data list based on the question text using a large model, to generate structured associated data;
performing optimization processing on the structured associated data, to generate a knowledge base collection; and
inputting the question text and the knowledge base collection into the large model, to enable the large model to generate an answer corresponding to the question text.

17. The non-transitory computer-readable storage medium of claim 16, wherein the computer instruction is used to cause the computer to execute the processing of the known data list based on the question text using the large model, to generate the structured associated data, by:
extracting a column definition from the known data list using the large model;
extracting a column related to the question text from the known data list according to the question text and the column definition using the large model, to generate a first associated list; and
extracting data of a relevant row from the first associated list according to the question text and the column definition using the large model, to generate the structured associated data.

18. The non-transitory computer-readable storage medium of claim 17, wherein the computer instruction is used to cause the computer to execute the extracting of the data of the relevant row from the first associated list according to the question text and the column definition using the large model, to generate the structured associated data, by:
determining a data type of a target column in the first associated list according to the column definition;
determining a constraint for filtering data of a relevant row according to the data type; and
extracting the data of the relevant row from the first associated list according to the constraint, to generate the structured associated data.

19. The non-transitory computer-readable storage medium of claim 16, wherein the computer instruction is used to cause the computer to execute the processing of the known data list based on the question text using the large model, to generate the structured associated data, by:
extracting a question keyword and a query condition according to the question text using the large model;
generating a structured query language based on the question keyword and the query condition using the large model; and
extracting the structured associated data related to the question text from the known data list using the structured query language.

20. The non-transitory computer-readable storage medium of claim 16, wherein the computer instruction is used to cause the computer to execute the performing of the optimization processing on the structured associated data, to generate the knowledge base collection, by:
extracting header information according to the structured associated data, the header information including a column name and its corresponding data type;
generating a knowledge list according to the structured associated data and the header information, the knowledge list including a structured data entry corresponding to the header information; and
performing row order adjustment and structural optimization on the knowledge list, to generate the knowledge base collection.
